(19) United States
(12) Patent Application Publication
(10) Pub. No.: US 2017/0300387 A1
(43) Pub. Date: Oct. 19, 2017

(54) Always Current backup and recovery method on large databases with minimum resource utilization.

(71) Applicant: Padhmanaban Durairaj, Gaithersburg, MD (US)

(72) Inventor: Padhmanaban Durairaj, Gaithersburg, MD (US)

(21) Appl. No.: 15/477,068

(22) Filed: Apr. 1, 2017

Related U.S. Application Data
(60) Provisional application No. 62/323,780, filed on Apr. 17, 2016.

(51) Int. Cl. G06F 11/14; G06F 17/30

(52) U.S. Cl. CPC G06F 11/1451; G06F 11/1469; G06F 17/30595

(57) ABSTRACT

A method to generate and maintain always current backup copy of database system with minimum system resource in a very large RDBMS or other database environment. Requiring one life time full backup only and then periodic differential backups unlike periodic full backups in current case. A method to use these backup files to recover to a point in time. Reducing time and resource utilization on very large database backup by applying these methods. This method eliminates the need to take periodic full backup copy on a database.

### BRIEF DESCRIPTION OF THE DRAWING

In the Drawings,

FIG. 1 illustrates a block diagram a full backup process to take the base backup file (BBF) along with creating the timestamp map file (TMF). This is equivalent to typical database backup method implemented in most commercial RDBMS setup.

FIG. 2 illustrates a differential backup performed after two pages have been changed in the database file. The two changed pages are copied to a diff backup file (DBF) and merged to base backup file (BBF). Before the merge the existing two pages on BBF has been preserved as pre-diff file (PDF). The timestamps of pages changed are copied to timestamp map file (TMF) from timestamp map.

FIG. 3 illustrates a differential backup performed after four new pages have been added in the database file. The four pages are copied to a diff backup file (DBF) and merged to base backup file (BBF). The timestamps of creation of four pages are copied to timestamp map file (TMF) from timestamp map.

FIG. 4 illustrates a point in time recovery to the database state at t3. The base backup file (BBF) is restored and the four pages created at t8 are demerged based on the timestamp map file (TMF) to bring the database file to t3 point in time.

### DESCRIPTION

### Technical Field

The Invention relates to any computer database systems or relational database management systems (RDBMS) systems in general and methods of producing backup dumps of the contents of database systems.

### Background

There is a need in all computer database systems to periodically take a full backup copy of the live database files. These files are used to recover the live database to a particular point in time in case a database file is corrupted or the computers which keep them fail. After a full backup the delta or difference in changes are backed up periodically as well. This is generally useful to avoid running the full backup copy more frequently and also to recover to a point in time. The differential backups are beneficial because the system resources required to run frequent full backup copy is very high. The time, storage devices, CPU, I/O, memory and network resources can be saved if full backup process is not run frequently. The cost saving is very high if the databases are bigger and the changes on them are frequent.

The most used method of producing a database backup in RDMBS products such as Microsoft's SQL Server or Oracle's RDMBS or IBM's DB2 is to establish a full backup copy as a base and to create differential/incremental backup and/or transaction log backup. The data is changed more frequently in modern database systems. In order to maintain durability of transaction the data both before and after the change is kept in a transactional log. The transactional log keeps the data before the change in order to rollback to original state if the transaction is cancelled or failed. Hence in any RDBMS three sets of backup are required. A base full copy then differential and/or transactional log backup to protect the data to a most recent point in time. This can be termed as ‘forward backup’. A periodic full backup is required to avoid keeping long list of differential or transaction log backup. If any intermediate backup file is missed then the recovery is limited to the point where the sequence of backup files complete.

### DETAILED DESCRIPTION

There is a risk of missing intermediate file and so there is limitation to complete the recovery to most recent point in time in using current method of backup and recovery. The method forces the system administrators to take full backup more frequently to reduce the risk of missing or corrupt intermediate files. The backup process in large databases will consume more resources such as CPU, memory, 10, network, disk/tape storages etc. Also the duration to complete the terabyte large backup may be several hours or days depending on resources available to this operation.

The invention proposes an always current method. This method avoids taking periodic full backup and eliminates the resource limitation. Hence the backup operations are limited to shorter duration and the resources required to this operation is minimal. The backup method requires a one-time full backup for the entire life of the database. This full backup creates a base backup file (BBF). After one full backup is taken the modified pages (extents or blocks) in database are copied periodically. This will be later merged with full copy file. The yet to be merged pages on the full backup file will be copied and kept separately as pre-diff file (PDF). PDF will be used during point in time recovery. The copied pages from database file will create a differential backup file (DDF). The pages in DDF will be merged to the base backup file (BBF). This process will continue periodically, say every 5 minutes. This process protects the data from disaster up to the time of 5 minutes. In case of disaster the base backup file (BBF) will be restored to the database system wherever needed. The BBF holds most recent data. If the recovery has to be prior to BBF data then the DDF and PDF files are used to demerge the pages to bring the database file to a point in time. During the demerge process the timestamp detail in TMF is used to identify the list of pages to demerge up until the point in time.

In current vendor supplied database systems a bitmap technique is used to track the pages changed in the database file between full and differential backups. The invention proposes a new way to track the changes. A timestamp map in the data file or a separate timestamp map (TM) within the database system to record the time of each changed page is proposed. The details in TM is copied during each backup run and is kept in timestamp map file (TMF). The TM will be reset after completion of backup and TM information is copied to TMF successfully.

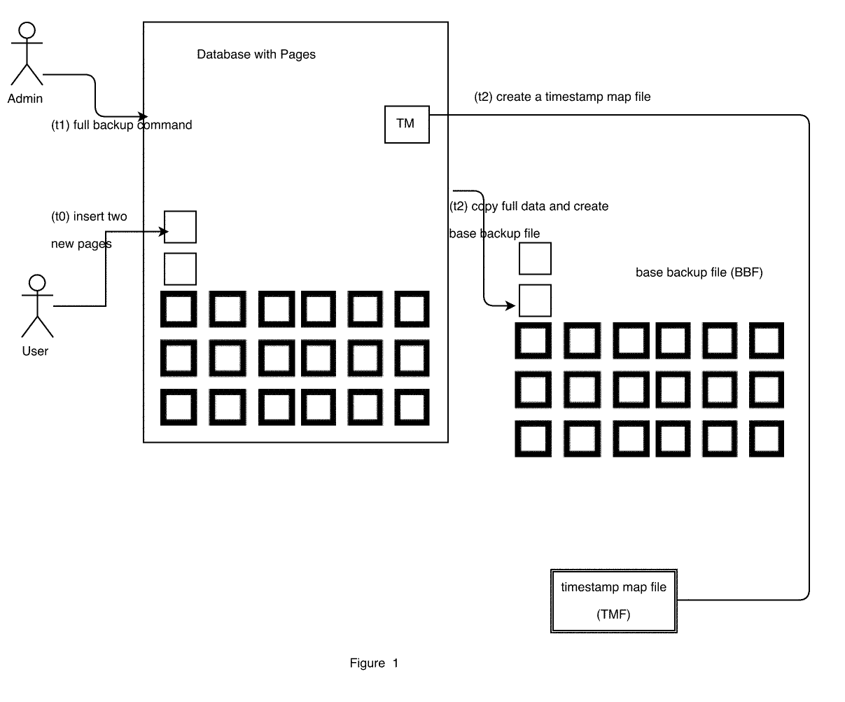

The processes shown in the FIGS. 1, 2, 3 and 4 are elaborated here:

The backup process is shown in FIGS. 1, 2 and 3. The empty database is inserted with initial data (t0) of 20 pages (FIG. 1). The database administrator sends a command to take a full backup (t1). Upon receiving the backup command the computer runs a full backup of the data base. At this point all 20 pages in the database are copied to a backup location (t2). This copy is considered as base backup file (BBF). A timestamp map file (TMF) is created as well (t2). TMF will have details from timestamp map (TM) which is empty at this time t2. The future changes in the database will be merged to BBF.

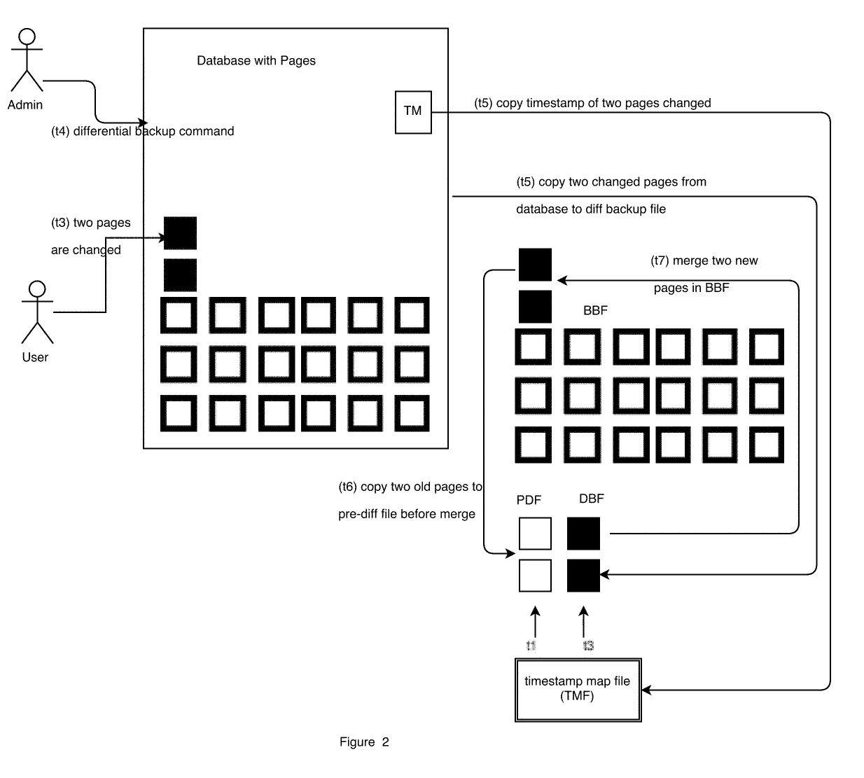

Two pages are changed at t3, highlighted in dark (FIG. 2). An administrator submits a differential backup command (t4). Upon firing the command these two pages are copied and a differential backup file (DBF) is created (t5) and the TMF is appended with timestamp at which the pages were originally changed. TMF gets this information from timestamp map (TM). The TM is reset. The two corresponding pages on BBF is copied and kept as pre-diff file (PDF) (t6). The two pages on DBF are merged to BBF (t7).

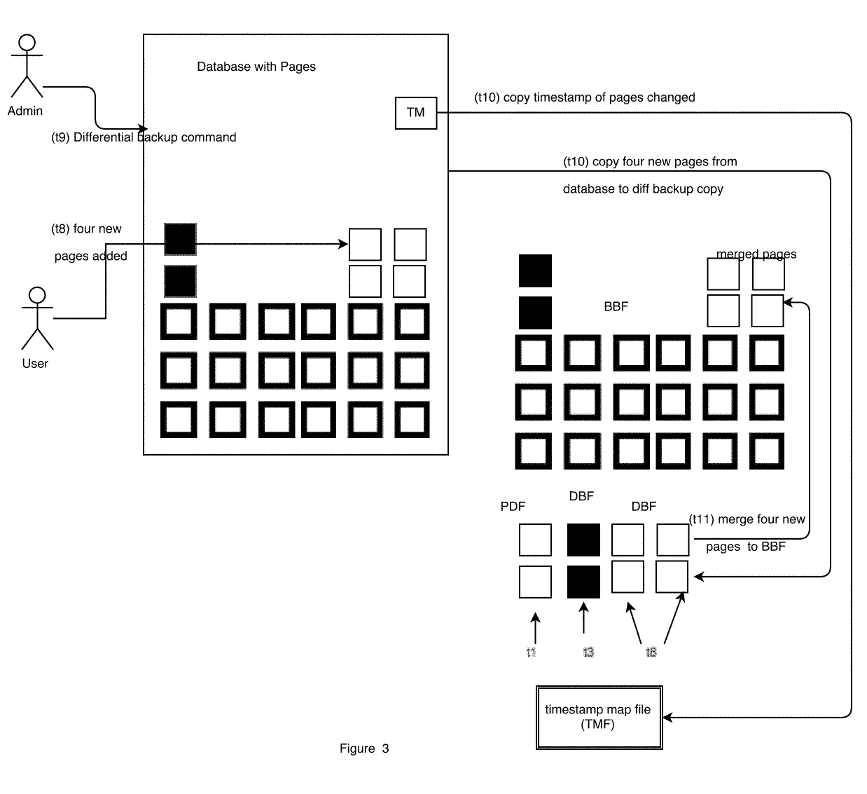

Four new pages are inserted to database file (t8) (FIG. 3). An administrator submits a differential backup command (t9). Upon firing the command the four pages are copied to a differential backup file (DBF) (t10). The timestamp of pages changed are copied from TM and appended to TMF. The TM is reset. Since there are no four matching pages on BBF a pre-diff file (PDF) is not created. The four pages on DDF are merged to BBF (t11). The PDF is not created in this process but the TMF holds detail about new pages which will fulfill the point in time recovery.

The current database systems track the changed pages by using a bitmap on each database files. With bitmap the recovery can happen up to the time before or after the differential backup process. It is not possible to have point in time recovery. In order to have specific point-in-time recovery timestamp of the changed pages should be retained instead of bitmap. The respective database vendors should implement timestamp map (TM) to retain the timestamp at which pages are changed in database file. This timestamp info will also be copied as part of proposed differential backup method and appended to TMF. A periodic process to prune the details from TMF to be performed if and when the PDF or DBF are purged from backup system. With this setup the recovery is possible up to an individual page when combined with the database checkpoint operation. The checkpoint operation is an established mechanism in any database management to flush the changed data pages to the disk storages.

A point-in-time Recovery up until t4:

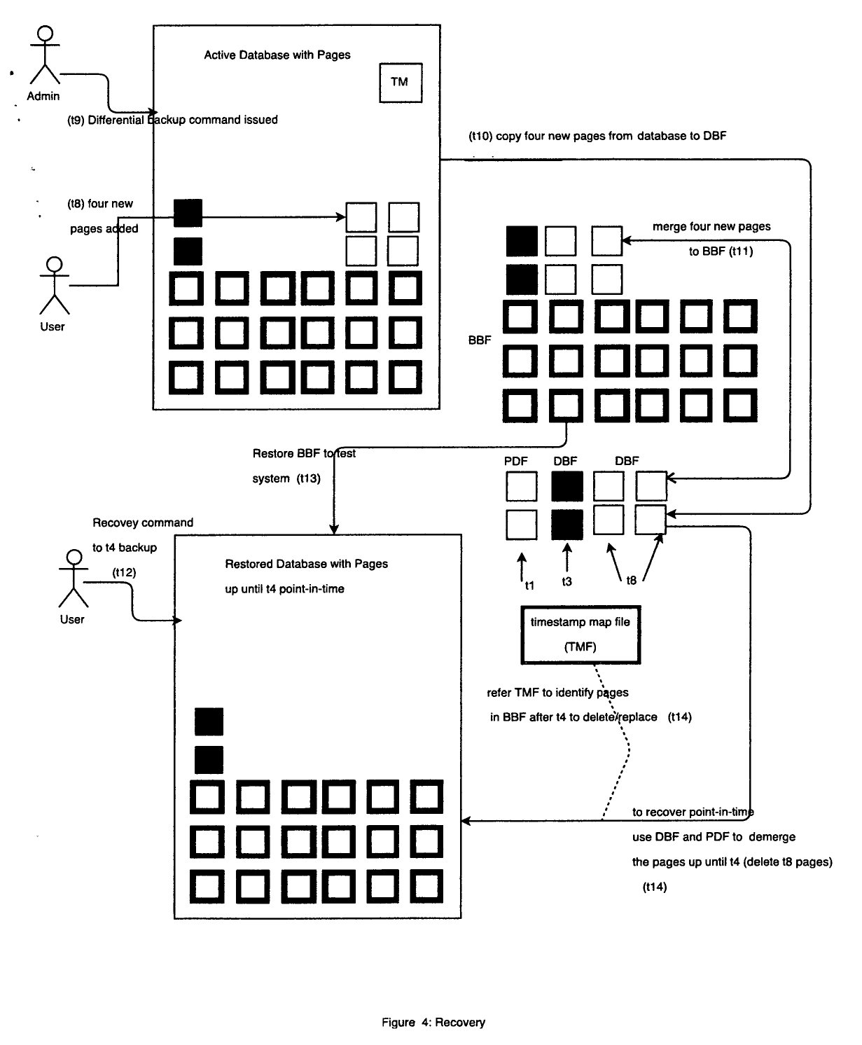

A need arises to recover the database up to a time (t4) into a test system (FIG. 4). The method requires 1) a restore process to copy entire base backup file (BBF) to the test system; 2) a process to read the timestamp map file (TMF) to list the pages merged to BBF after t4; and 3) a process to demerge the listed four pages on the restored test system database file. The database on test system has reached to t4 point-in-time recovery. Since the timestamp of changed page is retained instead of bitmap, the recovery can be up to a point in time.

### SUMMARY OF THE INVENTION

Databases need periodic full backup, differential and transaction log backups to maintain and protect them from any disaster such as disk failures, data corruption, user errors etc. The system resources consumed and the duration of such backups are serious problem in very large databases used in big data, analytical processing and large transactional processing. As databases grow bigger the current backup methods limit the data protection strategies. The above problems are solved and an advance is made in a method of generating a backup copy of a database system as illustrated in the figures and detailed description. The method eliminates the need to take periodic full database backups. In this method only one full backup is required for the entire life of the database. The onetime full backup is kept in a system and the pages changed after full backup on database are copied and merged to this base backup when the differential backup process is run. The pages on the base backup before and after the differential copy merge are kept separately for the point time recovery.

The pages modified after the full backup in database is summarized in a timestamp map on page or block or extent basis. The details in the timestamp map is copied and appended in the timestamp map file. The overhead of keeping a timestamp over bitmap is a trade-off. The trade-off is negligible for the 1) the resources saved by avoiding the frequent full backup will be much higher than few additional pages used to keep the timestamp and 2) it benefits the availability of current full backup at anytime.

What is claimed is:

1. A method of generating and maintaining an always current backup copy of a RDBMS or file based database, comprising the steps of:
a) executing a process to create an empty ‘timestamp map’ in the database;
b) performing a full backup of the database to create a base backup file (BBF) in a disk or storage;
c) executing a process to keep page address and timestamp of that page modified in the ‘timestamp map’;
d) executing a differential backup process on the database to copy the changed paged since last full or differential backup to a new diff backup file (DBF);
e) executing a process to merge the pages kept on the diff backup file (DBF) to the base backup file (BBF) and also to copy the pages before merge from the base backup file (BBF) to a pre-diff file (PDF);
f) executing a process to create a timestamp map file (TMF) and to append the ‘timestamp map’ information to it;
g) executing a process to reset the ‘timestamp map’ after a successful completion of step (e) and (f); and
h) repeating the method from (d).

2) A method to recover a database from the backup files and timestamp map file cited in claim 1, comprising the steps of:
a) executing a process to copy the base backup file (BBF) from backup disks to a computer where to restore;
b) executing a process to prepare a list of pages to be demerged on the base backup file (BBF) by reading the timestamp map file (TMF); and
c) executing a processes to demerge the individual pages to a point-in-time by applying the diff-backup files (DBF) one by one starting from the most recent DBF on the restored database.

3. The invention of claim 1, wherein creating timestamp map (TM) within the data file of the database or in a separate file.

4. The invention of claim 1, wherein creating the pre-diff file (PDF) and timestamp map file (TMF).
